(19) United States
(12) Patent Application Publication
(10) Pub. No.: US 2021/0095082 A1
(43) Pub. Date: Apr. 1, 2021

(54) Polyimide-Based Film and Flexible Display Panel Including the Same

(71) Applicants: SK Innovation Co., Ltd., Seoul (KR); SK IE Technology Co., Ltd., Seoul (KR)

(72) Inventors: Min Sang Park, Daejeon (KR); Keon Hyeok Ko, Daejeon (KR); Hye Jin Kim, Daejeon (KR); Yeong Min Jo, Daejeon (KR)

(21) Appl. No.: 17/034,767

(22) Filed: Sep. 28, 2020

(30) Foreign Application Priority Data
Sep. 30, 2019 (KR) 10-2019-0120883

(51) Int. Cl. C08J 5/18; G02F 1/1675

(52) U.S. Cl. CPC C08J 5/18; G02F 1/1675; G02F 2201/50; G02F 2202/022; C08J 2379/08

(57) ABSTRACT

Provided are a polyimide-based film, a window cover film, and a display panel including the same. More specifically, a polyimide-based film having a micro flexural modulus of 10 GPa or more and a micro flexural strength of 150 MPa or more is provided.

### CROSS-REFERENCE TO RELATED APPLICATION

This application claims priority to Korean Patent Application No. 10-2019-0120883 filed Sep. 30, 2019, the disclosure of which is hereby incorporated by reference in its entirety.

### TECHNICAL FIELD

The following disclosure relates to a polyimide-based film, a window cover film, and a display panel including the same.

### BACKGROUND

A thin display such as a liquid crystal display or an organic light emitting diode display is implemented in the form of a touch screen panel and is widely used in various smart devices characterized by portability including various wearable devices as well as smart phones and tablet PCs.

These portable touch screen panel-based displays are provided with a window cover for display protection on a display panel for protecting a display panel from external impact, and in recent years, as a foldable display device having flexibility to be folded and unfolded has been developed, a glass film as the window cover is replaced with a plastic film.

As the base material of the window cover film, polyethylene terephthalate (PET), polyether sulfone (PES), polyethylene naphthalate (PEN), polyacrylate (PAR), polycarbonate (PC), polyimide (PI), polyaramid (PA), polyamideimide (PAI), and the like, which are flexible and have transparency are used.

Besides, recently, required performance for flexibility is increasingly advanced, for example, various smart devices require flexibility and pliability and even require foldable properties so that they are folded.

However, until now, like the foldable display device, strict conditions of having no minor flaw such as curling due to folding while having a characteristic of satisfying high mechanical strength, optical properties, yellowness, and mechanical physical properties are required for a window cover film used in a display device requiring excessive flexible properties. In addition, since a general dynamic bending test proceeds, even though a bend fold is invisible to the naked eye, fine cracks which are invisible to the naked eye due to microbending loss may occur. In this case, the film will eventually fail the bending test by subtle but periodic force when uneven pressure is applied. Therefore, a film having no fine cracks (<200 um) even in microbending is needed.

For example, since the film may withstand mechanical stress and prevent a viewing angle from varying even during long-term use without changing optical physical properties only when a micro flexural modulus and a micro flexural strength are excellent and fine cracks do not occur in repeated folding tests corresponding to a usual display life even in microfolding properties, development of a window cover film satisfying the properties is currently needed.

In particular, development of a window substrate for protection for being applied to a sufficiently flexible display, which has a high bending strength, has no curl due to contraction and elongation by folding in spite of having such a high bending strength, and is sufficiently flexible, is currently further needed.

### Related Art Documents

[Patent Documents]

(Patent Document 1) Korean Patent Laid-Open Publication No. 10-2013-0074167 (Jul. 4, 2013)

### SUMMARY

An embodiment of the present invention is directed to providing a polyimide-based film for a window cover having improved durability and mechanical properties. A polyimide-based film for a window cover having improved mechanical properties, which has a characteristic of having excellent strength of preferably a micro flexural modulus of 10 GPa more and a micro flexural strength of 150 MPa or more, and more preferably a micro flexural modulus of 15 GPa or more and a micro flexural strength of 200 MPa or more, is intended to be provided.

Another embodiment of the present invention is directed to providing a novel window cover film which has no curl even with expansion and contraction inside and outside by folding.

Specifically, a polyimide-based film, which has no fine cracks even when bending is repeated 10,000 times or more, more preferably 30,000 times, and still more preferably 50,000 times and may be applied to a surface of a display and the like having a curved shape and a window cover film using the same, is intended to be provided.

Still another embodiment of the present invention is directed to providing a flexible display panel having improved durability and mechanical properties.

In one general aspect, a polyimide-based film having a micro flexural modulus of 10 to 20 GPa or more and a micro flexural strength of 150 MPa or more is provided. Here, the micro flexural modulus and the micro flexural strength refer to a modulus of elasticity and a strength measured as follows: a film having a width of 10 mm and a length of 20 mm is placed between a lower anvil and an upper anvil of a micro 3-point bend fixture including two lower anvils each spaced at an interval of 4 mm and one upper anvil having a radius of 0.25 mm, a preload of 0.2 N is applied at a rate of 1 mm/min using a load cell of 50 N, and then the film is pressed at a rate of 1 mm/min until a flexural strain of 2% is achieved, the modulus of elasticity and the strength being measured from a flexural stress applied thereto.

In an exemplary embodiment of the present invention, the polyimide-based film may have a micro flexural modulus of 15 GPa or more and a micro flexural strength of 200 MPa or more.

In an exemplary embodiment of the present invention, the polyimide-based film may have a flexural displacement of 0.5 to 0.7 mm. Herein, the flexural displacement refers to a displacement measured when a flexural strain of 2% is achieved.

In an exemplary embodiment of the present invention, the polyimide-based film may satisfy the following Relation:

0.5<A/B<1.0

wherein A is a flexural stress value (MPa) when a flexural strain is 1%, and B is a flexural stress value (MPa) when a flexural strain is 2%.

In an exemplary embodiment of the present invention, the polyimide-based film may have an elongation at break according to ASTM D882 of 8% or more.

In an exemplary embodiment of the present invention, the polyimide-based film may have a light transmittance of 5% or more as measured at 388 nm according to ASTM D1746, a total light transmittance of 87% or more as measured at 400 to 700 nm, a haze of 2.0% or less, a yellowness of 5.0 or less, and a b* value of 2.0 or less.

In an exemplary embodiment of the present invention, the polyimide-based film may include a polyamideimide structure.

In an exemplary embodiment of the present invention, the polyimide-based film may include a unit derived from a fluorine-based aromatic diamine, a unit derived from an aromatic dianhydride, and a unit derived from an aromatic diacid dichloride.

In an exemplary embodiment of the present invention, the polyimide film may further include a unit derived from a cycloaliphatic dianhydride. That is, the polyimide-based film may include a unit derived from a cycloaliphatic dianhydride, a unit derived from a fluorine-based aromatic diamine, a unit derived from an aromatic dianhydride, and a unit derived from an aromatic diacid dichloride.

In an exemplary embodiment of the present invention, the polyimide-based film may have a thickness of 10 to 500 μm.

In another general aspect, a window cover film includes any one polyimide-based film selected from the above exemplary embodiment; and a coating layer formed on one surface of the polyimide-based film.

In an exemplary embodiment of the present invention, the coating layer may be any one or more selected from an antistatic layer, an anti-fingerprint layer, an antifouling layer, an anti-scratch layer, a low-refractive layer, an antireflective layer, and shock absorption layer.

In another general aspect, a flexible display panel includes the window cover film according to the exemplary embodiment.

In still another general aspect, a flexible display panel includes the polyimide-based film according to the exemplary embodiment.

Other features and aspects will be apparent from the following detailed description, the drawings, and the claims.

### BRIEF DESCRIPTION OF THE DRAWINGS

FIGS. 1 and 2 are drawings illustrating a method of measuring dynamic bending properties of a polyimide-based film according to an exemplary embodiment of the present invention.

FIG. 3 is a photograph showing that cracks did not occur when measuring dynamic bending.

FIG. 4 is a photograph showing that cracks occurred when measuring dynamic bending.

### DETAILED DESCRIPTION OF EMBODIMENTS

Hereinafter, the present invention will be described in more detail with reference to specific examples and exemplary embodiments including the accompanying drawings. However, the following specific examples or exemplary embodiments are only a reference for describing the present invention in detail, and the present invention is not limited thereto, and may be implemented in various forms.

In addition, unless otherwise defined, all technical terms and scientific terms have the same meanings as those commonly understood by a person skilled in the art to which the present invention pertains. The terms used in the description of the invention are only for effectively describing a certain specific example, and are not intended to limit the present invention.

In addition, the singular form used in the specification and claims appended thereto may be intended to also include a plural form, unless otherwise indicated in the context.

In addition, unless particularly described to the contrary, “comprising” any elements will be understood to imply further inclusion of other elements rather than the exclusion of any other elements.

In the present invention, a polyimide-based resin is used as a term including a polyimide resin or a polyamideimide resin. A polyimide-based film is used likewise.

In the present invention, a “polyimide-based resin solution” is used in the same meaning as a “composition for forming a polyimide-based film” and a “polyamideimide solution”.

In addition, a polyimide-based resin and a solvent may be included for forming the polyimide-based film.

In the present invention, a “film” is obtained by applying and drying the “polyimide-based resin solution” on a support and carrying out peeling off, and may be stretched or unstretched.

In the present invention, “dynamic bending properties” may mean that even when a polyimide-based film is repeatedly deformed (for example, folded and unfolded), permanent deformation and/or damage does/do not occur in a deformed part (for example, a folded part).

The inventors of the present invention conducted many studies in order to solve the above problems, and as a result, found that when a polyimide-based film, which satisfies both physical properties of a micro flexural modulus of 10 GPa or more and a micro flexural strength of 150 MPa or more is used, a window cover film having greatly improved mechanical strength, flexibility, and dynamic bending properties to prevent cracking in spite of repeated occurrence of predetermined deformation, is prepared, thereby completing the present invention.

In addition, in the present invention, it was confirmed that in order to satisfy the micro flexural modulus and the micro flexural strength, a polyimide-based film using a polyimide-based resin including a fluorine atom and an aliphatic cyclic ring structure, more preferably a polyamideimide resin which includes a specific monomer composition including a fluorine atom and an aliphatic cyclic ring structure and is prepared by the preparation method of the present invention in which an amine-terminal polyamide oligomer having a polyamide repeating unit is prepared and reacted with a dianhydride, is used to achieve the object of the present invention, thereby completing the present invention.

The fact that the dynamic bending properties are excellent or improved may mean that even when a film is repeatedly deformed, specifically, repeatedly folded and unfolded, deformation does not occur, and as an example, fine cracks do not occur.

Specifically, the dynamic bending may mean that cracks do not occur in the dynamic bending of 10,000 times or more, preferably 30,000 times or more, more preferably 50,000 times or more, when measuring the dynamic bending using a measuring device by the measurement method of the present invention. The crack may mean a fine crack. The term “fine crack” used in the present specification may mean a crack having a size which is usually not observed by the naked eye.

The crack may be a fine crack, for example, a fine crack having a width of 0.5 μm or more and a length of 10 μm or more and may be a micro-fine crack which may be observed by a microscope rather than the naked eye. When the film satisfies the micro flexural modulus, the micro flexural strength, and the dynamic bending properties, the film may be applied to a window cover film, and more preferably, may be applied to a foldable window cover film.

In addition, the polyimide-based film of the present invention is a thin film having a thickness of 10 to 500 μm, and as such, when a flexural modulus and a bending strength of a micrometer-thick film are measured by a method such as a method according to ASTM D790 which is a method of measuring the flexural modulus and the bending strength of a general plastic product, the correct values thereof may not be measured.

Thus, the inventors of the present invention measured a stress and a bending strength applied to a thin film having a micrometer thickness when fine flexural strain occurs thereon, using the following specific measuring equipment for measuring the properties.

That is, in the present invention, the micro flexural modulus and the micro flexural strength are measured using a micro 3-point bend fixture including two lower anvils spaced at an interval of 4 mm and one upper anvil having a radius of 0.25 mm, as follows: a film having a width of 10 mm, a length of 20 mm, and a thickness of 20 to 100 μm is placed between the lower anvil and the upper anvil, a preload of 0.2 N is applied at a rate of 1 mm/min using a load cell of 50 N, and then the film is pressed at a rate of 1 mm/min until a flexural strain of 2% is achieved, the micro flexural modulus and the micro flexural strength being determined from a stress applied thereto.

More specifically, a micro 3-point bend fixture (Instron, CAT. #2810-411) was used for measuring a bending strength due to fine deformation of a thin film. A sample was placed on two lower anvils and then a load was applied to one upper anvil. Here, the used anvil has a radius of 0.25 mm. The loading was applied precisely to a span center between the two lower anvils. In the experiment, a supported span of the lower anvil was 4 mm. Here, the size of the sample is prepared to have a width of 10 mm and a length of 20 mm. A test is performed by mounting a static load cell (CAT# 2530-50N) of 50 N on a single column tabletop testing system (CAT# 5942) from Instron, applying a preload of 0.2 N at a rate of 1 mm/min, and then pressing at a rate of 1 mm/min until a flexural strain of 2% is achieved. A pressed circular cross section had a diameter of 3 mm. An exact flexural displacement is precisely measured using Advanced Video Extensometer 2 (AVE 2, CAT# 2663-901) from Instron. AVE 2 tracked deformation of the part indicated in the sample using a built-in camera in a non-contacting optical extensometer. Finally, a stress applied until a flexural strain of 2% is achieved is measured in 100 ms increments to determine the micro flexural strength and the micro flexural modulus (@ 2% strain). The micro flexural modulus, strength, and strain are values calculated based on an input program in Testing System from Instron.

The polyimide-based film according to an exemplary embodiment of the present invention is characterized by having the micro flexural modulus in a range of 10 GPa or more, specifically 10 to 20 GPa and the micro flexural strength in a range of 150 MPa or more, when measuring the physical properties as described above. Preferably, the micro flexural modulus may be 12 GPa or more, 14 GPa or more, and more preferably 15 GPa or more. The upper limit is not limited, but specifically, may be 10 to 90 GPa. In addition, the micro flexural strength may be preferably 160 MPa or more, 180 MPa or more, and more preferably 200 MPa or more. The upper limit is not limited, but specifically, may be 150 to 500 MPa.

The polyimide-based film according to an exemplary embodiment of the present invention may have the flexural displacement of 0.5 to 0.7 mm (wherein the flexural displacement means a displacement measured when a flexural strain of 2% is achieved). When measured at the flexural strain in a range of 2%, the micro flexural modulus and the micro flexural strength which are reproducible and reliable for fine deformation may be obtained.

The polyimide-based film according to an exemplary embodiment of the present invention may satisfy a relation of 0.5<A/B<1.0 (wherein A is a flexural stress value (MPa) when a flexural strain is 1%, and B is a flexural stress value (MPa) when a flexural strain is 2%). Within the range satisfying the relation, elastic properties are strong to show excellent micro flexural properties, and within the range, the bending properties required for the flexible window cover may be satisfied.

The polyimide-based film according to an exemplary embodiment of the present invention may have no cracks in the dynamic bending of 10,000 times or more, preferably 30,000 times or more, and more preferably 50,000 times or more, when measuring the dynamic bending properties. Specifically, the fact that the dynamic bending properties are excellent or improved may mean that even when the window cover film is repeatedly deformed, specifically, repeatedly folded and unfolded, deformation does not occur, and as an example, cracks do not occur.

The crack may mean a fine crack. The term “fine crack” used in the present specification may mean a crack having a size which is usually not observed by the naked eye. The fine crack may mean a crack having a width of 0.5 μm or more and a length of 10 pm or more, and may be observed by a microscope.

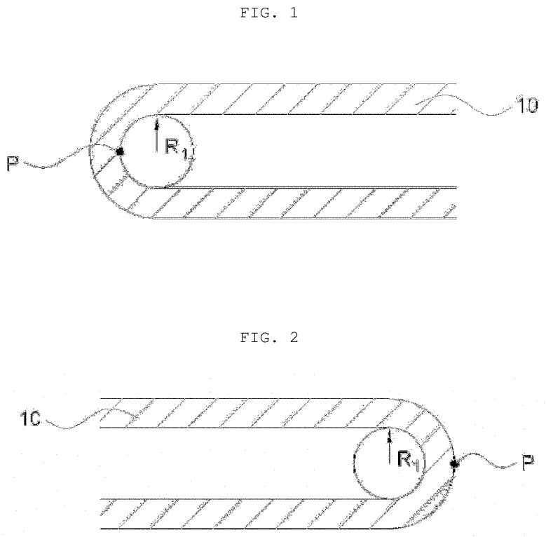

FIGS. 1 and 2 are drawings illustrating a method of measuring the dynamic bending properties of a polyimide-based film 10 according to an exemplary embodiment of the present invention. As shown in FIG. 1, an operation of winding one surface of the polyimide-based film around a cylinder having a radius (Rd of 5 mm to fold the surface is repeatedly performed at a rate of 60 cycles/min, and as shown in FIG. 2, the same operation is repeatedly performed on an opposite surface at a rate of 60 cycles/min, so that the surface is folded at the same position (P), thereby measuring the dynamic bending properties.

Generally, a flexible display device such as foldable instrumentation involves repeated deformation (folding) in use. When the fine cracks occur in deformation, the number of fine cracks is increased as deformation is repeated. Accordingly, fine cracks may gather to form visually recognized cracks. In addition, as the number of cracks is increased, the flexibility of the flexible display device may be decreased to cause fracture in additional folding, and moisture and the like may penetrate into the cracks to decrease durability of the flexible display device.

The polyimide-based film according to exemplary embodiments of the present invention may substantially prevent occurrence of the fine cracks to secure the durability and long-term life of the display device.

Hereinafter, the polyimide-based film according to an exemplary embodiment will be described in more detail.

<Polyimide-Based Film>

In an exemplary embodiment of the present invention, the polyimide-based film has excellent optical physical properties and mechanical physical properties, and may be formed of a material having elasticity and restoring force.

In an exemplary embodiment of the present invention, the polyimide-based film may have a thickness of 10 to 500 μm, 20 to 250 μm, or 30 to 110 μm.

In an exemplary embodiment of the present invention, the polyimide-based film may have an elongation at break according to ASTM D882 of 8% or more, 12% or more, or 15% or more, a light transmittance of 5% or more or 5 to 80% as measured at 388 nm according to ASTM D1746, a total light transmittance of 87% or more, 88% or more, or 89% or more as measured at 400 to 700 nm, a haze according to ASTM D1003 of 2.0% or less, 1.5% or less, or 1.0% or less, a yellowness according to ASTM E313 of 5.0 or less, 3.0 or less, or 0.4 to 3.0, and a value of 2.0 or less, 1.3 or less, or 0.4 to 1.3.

In an exemplary embodiment of the present invention, the polyimide-based film is a polyimide-based resin, in particular, a polyimide-based resin having a polyamideimide structure.

In addition, more preferably, the polyimide-based film may be a polyamideimide-based resin including a fluorine atom and an aliphatic cyclic structure, and thus, may have a characteristic of excellent appearance quality, mechanical physical properties, and dynamic bending properties, while satisfying the micro flexural modulus in a range of 10 GPa or more and the micro flexural strength in a range of 150 MPa or more.

In an exemplary embodiment of the present invention, as an example of the polyamideimide-based resin including a fluorine atom and an aliphatic cyclic structure, a polyamideimide polymer prepared by preparing an amine-terminal polyamide oligomer derived from a first fluorine-based aromatic diamine and an aromatic diacid dianhydride and polymerizing a monomer derived from the amine-terminal polyamide oligomer, a second fluorine-based aromatic diamine, an aromatic dianhydride, and a cycloaliphatic dianhydride, is preferred, since it achieves the object of the present invention better. The first fluorine-based aromatic diamine and the second fluorine-based aromatic diamine may be the same or different kinds.

In an exemplary embodiment of the present invention, when the amine-terminal oligomer having an amide structure in a polymer chain by the aromatic diacid dichloride is included as the monomer of the diamine, mechanical strength including the micro flexural modulus may be improved as well as the optical physical properties are improved, and also the dynamic bending properties may be further improved.

In an exemplary embodiment of the present invention, when the polyamide oligomer block is included, a mole ratio between a diamine monomer including the amine-terminal polyoligomer and the second fluorine-based aromatic diamine and a dianhydride monomer including the aromatic dianhydride and the cycloaliphatic dianhydride of the present invention may be 1:0.9 to 1.1, preferably 1:1. In addition, a content of the amine-terminal polyamide oligomer with respect to the entire diamine monomer is not particularly limited, but 30 mol % or more, preferably 50 mol % or more, and more preferably 70 mol % or more is more preferred for satisfying the mechanical physical properties, the yellowness, and the optical properties of the present invention. In addition, a composition ratio of the aromatic dianhydride and the cycloaliphatic dianhydride is not particularly limited; however, a ratio of 30 to 80 mol %:70 to 20 mol % is preferred considering the transparency, the yellowness, and the mechanical physical properties of the present invention, but the ratio is not necessarily limited thereto.

In an exemplary embodiment of the present invention, as the polyamideimide-based resin, a quaternary copolymer including all of a unit derived from a fluorine-based aromatic diamine, a unit derived from an aromatic dianhydride, a unit derived from a cycloaliphatic dianhydride, and a unit derived from an aromatic diacid dichloride is used, thereby satisfying appearance quality and optical properties to be desired, which is thus more preferred.

In addition, in the present invention, another example of the polyamideimide-based resin including a fluorine atom and an aliphatic cyclic structure may be a polyamideimide-based resin obtained by mixing, polymerizing, and imidizing the fluorine-based aromatic diamine, the aromatic dianhydride, the cycloaliphatic dianhydride, and the aromatic diacid dichloride. The resin has a random copolymer structure, may include a content of the aromatic diacid dichloride of 40 mol or more, preferably 50 to 80 mol, a content of the aromatic dianhydride of 10 to 50 mol, and a content of the cycloaliphatic dianhydride of 10 to 60 mol, and may be prepared by polymerization at a mole ratio of a sum of a diacid chloride and a dihydrate to the diamine monomer of 1:0.8 to 1.1. Preferably, polymerization is performed at a mole ratio of 1:1. The random polyamideimide of the present invention is somewhat different in the optical properties such as transparency and mechanical physical properties as compared with the block polyamideimide resin, but may belong to the range of the present invention.

In an exemplary embodiment of the present invention, as the fluorine-based aromatic diamine component, 2,2′-bis(trifluoromethyl)-benzidine and another known aromatic diamine component may be mixed and used, but 2,2′-bis(trifluoromethyl)-benzidine may be used alone. By using the fluorine-based aromatic diamine as such, excellent optical properties may be improved, based on the mechanical physical properties required in the present invention, and the yellowness may be improved, as the polyamideimide-based film. In addition, the micro flexural modulus of the polyamideimide-based film may be improved to improve the mechanical strength of the hard coating layer and further improve the dynamic bending properties.

The aromatic dianhydride may be at least one or a mixture of two or more of 4,4′-hexafluoroisopropylidene diphthalic anhydride (6FDA) and biphenyltetracarboxylic dianhydride (BPDA), oxydiphthalic dianhydride (ODPA), sulfonyl diphthalic anhydride (SO2DPA), (isopropylidenediphenoxy) bis(phthalic anhydride)(6HDBA), 4-(2,5-dioxotetrahydrofuran-3-yl)-1,2,3,4-tetrahydronaphthalene-1,2-dicarboxylic dianhydride (TDA), 1,2,4,5-benzene tetracarboxylic dianhydride (PMDA), benzophenone tetracarboxylic dianhydride (BTDA), bis(carboxylphenyl) dimethyl silane dianhydride (SiDA), bis(dicarboxyphenoxy) diphenyl sulfide dianhydride (BDSDA), but the present invention is not limited thereto.

As an example of the cycloaliphatic dianhydride, any one or a mixture of two or more selected from the group consisting of 1,2,3,4-cyclobutanetetracarboxylic dianhydride (CBDA), 5-(2,5-dioxotetrahydrofuryl)-3-methylcyclohexene-1,2-dicarboxylic dianhydride (DOCDA), bicyclo[2.2.2]oct-7-en-2,3,5,6-tetracarboxylic dianhydride (BTA), bicyclooxtene-2,3,5,6-tetracarboxylic dianhydride (BODA), 1,2,3,4-cyclopentanetetracarboxylic dianhydride (CPDA), 1,2,4,5-cyclohexanetetracarboxylic dianhydride (CHDA), 1,2,4-tricarboxy-3-methylcarboxycyclopentane dianhydride (TMDA), 1,2,3,4-tetracarboxycyclopentane dianhydride (TCDA), and derivatives thereof may be used.

In an exemplary embodiment of the present invention, when the amide structure is formed in the polymer chain by the aromatic diacid dichloride, mechanical strength including the micro flexural modulus may be greatly improved as well as the optical physical properties are improved, and also the dynamic bending properties may be further improved.

As the aromatic diacid dichloride, a mixture of two or more selected from the group consisting of isophthaloyl dichloride (IPC), terephthaloyl dichloride (TPC), [1,1′-Biphenyl]-4,4′-dicarbonyl dichloride (BPC), 1,4-naphthalene dicarboxylic dichloride (NPC), 2,6-naphthalene dicarboxylic dichloride (NTC), 1,5-naphthalene dicarboxylic dichloride (NEC), and derivatives thereof may be used, but is not limited thereto.

In the present invention, a weight average molecular weight of the polyimide resin is not particularly limited, but may be 200,000 g/mol or more, preferably 300,000 g/mol or more, and more preferably 200,000 to 500,000 g/mol. In addition, a glass transition temperature is not limited, but may be 300 to 400° C., more specifically 330 to 380° C. Within the range, since a film having a high modulus, an excellent mechanical strength, excellent optical physical properties, and less curling may be provided, the range is preferred, but the present invention is not necessarily limited thereto.

Hereinafter, a method of preparing the polyimide-based film will be illustrated.

In an exemplary embodiment of the present invention, the polyimide-based film may be prepared by applying a “polyimide-based resin solution” including a polyimide-based resin and a solvent on a substrate, and performing drying or drying and stretching. That is, the polyimide-based film may be prepared by a solution casting method.

As an example, the polyimide-based film may be prepared by including: reacting a fluorine-based aromatic diamine and an aromatic diacid dichloride to prepare an oligomer, reacting the prepared oligomer with the fluorine-based aromatic diamine, an aromatic dianhydride, and a cycloaliphatic dianhydride to prepare a polyamic acid solution, imidizing the polyamic acid solution to prepare a polyamideimide resin, and applying a polyamideimide solution in which a polyamideimide resin is dissolved in an organic solvent to form a film.

Hereinafter, each step will be described in more detail, taking a case in which a block polyamideimide film is prepared as an example.

The step of preparing an oligomer may include reacting the fluorine-based aromatic diamine and the aromatic diacid dichloride and purifying and drying the obtained oligomer. In this case, the fluorine-based aromatic diamine may be introduced at a mole ratio of 1.01 to 2 with respect to the aromatic diacid dichloride to prepare an amine-terminal polyamide oligomer monomer. A molecular weight of the oligomer monomer is not particularly limited, but for example, when the weight average molecular weight is in a range of 1000 to 3000 g/mol, better physical properties may be obtained.

In addition, it is preferred to use an aromatic carbonyl halide monomer such as terephthaloyl chloride or isophthaloyl chloride, not terephthalic ester or terephthalic acid itself for introducing an amide structure, and this is, though not clear, considered to influence the physical properties of the film by a chlorine element.

Next, the step of preparing a polyamic acid may be performed by a solution polymerization reaction in which the prepared oligomer with the fluorine-based aromatic diamine, the aromatic dianhydride, and the cycloaliphatic dianhydride are reacted in an organic solvent. Here, the organic solvent used for the polymerization reaction may be, as an example, any one or two or more polar solvents selected from dimethylacetamide (DMAc), N-methyl-2-pyrrolidone (NMP), dimethylformamide (DMF), dimethylsulfoxide (DMSO), ethylcellosolve, methylcellosolve, acetone, ethylacetate, m-cresol, and the like.

More specifically, the fluorine-based aromatic diamine and the aromatic diacid dichloride are reacted to prepare an intermediate in the form of an oligomer including an amide unit, and then the oligomer is reacted with the fluorine-based aromatic diamine, the aromatic dianhydride, and the cycloaliphatic dianhydride to prepare a polyamic acid solution, thereby preparing a polyamideimide-based film in which the amide intermediate is uniformly distributed. As such, the amide intermediate is uniformly distributed in the entire film, whereby mechanical properties are excellent, optical properties are excellent, and coatability and coating uniformity of a coating composition used in a post-coating process of the hard coating layer or the like are further improved on the entire area of the film to further improve the optical physical properties of the final window cover film, and thus, a film having excellent optical properties without occurrence of an optical stain such as rainbow and mura may be provided.

Next, the step of imidizing to prepare a polyamideimide resin may be performed by chemical imidization, and more preferably, a polyamic acid solution is chemically imidized using pyridine and an acetic anhydride. Subsequently, imidization is performed using an imidization catalyst and a dehydrating agent at a low temperature of 150° C. or lower, preferably 100° C. or lower, and more preferably 50 to 150° C.

By the method as such, uniform mechanical physical properties may be imparted to the entire film as compared with the case of an imidization reaction by heat at a high temperature.

As the imidization catalyst, any one or two or more selected from pyridine, isoquinoline, and β-quinoline may be used. In addition, as the dehydrating agent, any one or two or more selected from an acetic anhydride, a phthalic anhydride, a maleic anhydride, and the like may be used, but is not necessarily limited thereto.

In addition, an additive such as a flame retardant, an adhesion improver, inorganic particles, an antioxidant, a UV inhibitor, and a plasticizer may be mixed with the polyamic acid solution to prepare the polyamideimide resin.

In addition, after imidization, the resin is purified using a solvent to obtain a solid content, which is dissolved in a solvent to obtain a polyamideimide solution. The solvent may include N,N-dimethyl acetamide (DMAc) and the like, but is not limited thereto.

The step of forming a film from the polyamideimide solution is performed by applying the polyamideimide solution on a substrate, and then drying the solution in a drying step divided into a dry area. In addition, stretching may be performed before or after the drying, and a heat treatment step may be further performed after the drying or stretching step. As the substrate, for example, glass, stainless, a film, or the like may be used, but is not limited thereto. Application may be performed by a die coater, an air knife, a reverse roll, spraying, a blade, casting, gravure, spin coating, and the like.

<Window Cover Film>

In addition, another exemplary embodiment of the present invention provides a window cover film including: the polyimide-based film described above; and a coating layer formed on the polyimide-based film.

When the coating layer is laminated on the polyimide-based film having a certain range of a surface hardness change rate, a window cover film having significantly improved visibility may be provided.

In an exemplary embodiment of the present invention, the window cover film may satisfy the physical properties of a light transmittance of 3% or more as measured at 388 nm according to ASTM D1746, a total light transmittance of 87% or more, 88% or more, or 89% or more as measured at 400 to 700 nm, a haze according to ASTM D1003 of 1.5% or less, 1.2% or less, or 1.0% or less, a yellowness according to ASTM E313 of 4.0 or less, 3.0 or less, or 2.0 or less, and a b* value of 2.0 or less, 1.5 or less, or 1.2 or less.

According to an exemplary embodiment of the present invention, the coating layer is for imparting functionality of the window cover film, and may be variously applied depending on its purpose.

Specifically, for example, the coating layer may include any one or more layers selected from a restoration layer, an impact spread layer, a self-cleaning layer, an anti-fingerprint layer, an anti-scratch layer, a low-refractive layer, an impact absorption layer, and the like, but is not limited thereto.

Even in the case in which various coating layers as described above are formed on the polyimide-based film, a window cover film having excellent display quality, high optical properties, and a significantly reduced rainbow phenomenon, may be provided.

In an exemplary embodiment of the present invention, specifically, the coating layer may be formed on one surface or both surfaces of the polyimide-based film. For example, the coating layer may be disposed on an upper surface of the polyimide-based film, or disposed on each of an upper surface and a lower surface of the polyimide-based film. The coating layer may protect the polyimide-based film having excellent optical and mechanical properties from external physical or chemical damage.

In an exemplary embodiment of the present invention, the coating layer may have a solid content of 0.01 to 200 g/m², based on a total area of the polyimide-based film. Preferably, the solid content may be 20 to 200 g/m², based on the total area of the polyimide-based film. By providing the basis weight described above, surprisingly, the film may not cause a rainbow phenomenon while maintaining functionality to implement excellent visibility.

In an exemplary embodiment of the present invention, specifically, the coating layer may be formed by applying the coating layer in the state of a composition for forming a coating layer including a coating solvent on the polyimide-based film. The coating solvent is not particularly limited, but preferably, may be a polar solvent. For example, the polar solvent may be any one or more solvents selected from an ether-based solvent, a ketone-based solvent, an alcohol-based solvent, an amide-based solvent, a sulfoxide-based solvent, an aromatic hydrocarbon-based solvent, and the like. Specifically, the polar solvent may be any one or more solvents selected from dimethylacetamide (DMAc), N-methyl-2-pyrrolidone (NMP), dimethylformamide (DMF), dimethylsulfoxide (DMSO), acetone, ethylacetate, propylene glycol methyl ether, m-cresol, methanol, ethanol, isopropanol, butanol, 2-methoxyethanol, methylcellosolve, ethylcellosolve, methyl ethyl ketone, methyl butyl ketone, methyl isobutyl ketone, methyl phenyl ketone, diethyl ketone, dipropyl ketone, cyclohexanone, hexane, heptane, octane, benzene, toluene, xylene, and the like.

In an exemplary embodiment of the present invention, as a method of forming the coating layer by applying the composition for forming a coating layer on the polyimide-based film, any one or more methods selected from a spin coating method, a dipping method, a spraying method, a die coating method, a bar coating method, a roll coater method, a meniscus coating method, a flexo printing method, a screen printing method, a bead coating method, an airknife coating method, a reverse roll coating method, a blade coating method, a casting coating method, a gravure coating method, and the like, may be used, but is not limited thereto.

In an exemplary embodiment of the present invention, the window cover film may further include a substrate layer. The substrate layer may be formed on the other surface of the polyimide-based film on which the coating layer is not formed.

In an exemplary embodiment of the present invention, the polyimide-based film may be laminated on the substrate layer after being produced into a film, or may be laminated after applying a polyamic acid resin composition which is a precursor of the polyimide-based film to be coated, but is not particularly limited as long as it may form a lamination configuration described above.

In an exemplary embodiment of the present invention, the substrate layer is not particularly limited as long as it is a substrate film of a commonly used window cover film, but for example, may include any one or more selected from an ester-based polymer, a carbonate-based polymer, a styrene-based polymer, an acryl-based polymer, and the like. Specifically, for example, the substrate layer may include any one or more selected from polyethylene terephthalate, polyethylene naphthalate, polybutylene terephthalate, polybutylene naphthalate, polycarbonate, polystyrene, polymethylmethacrylate, and the like, but is not limited thereto.

In an exemplary embodiment of the present invention, the substrate layer may be a single layer or a multiple layer in which two or more layers are laminated. Specifically, the substrate layer may include an optical adhesive layer on an interface of two or more substrate films and be laminated.

According to an exemplary embodiment of the present invention, the substrate layer may have a thickness of 50 to 300 μm. The thickness may be preferably 100 to 300 μm, and more preferably 150 to 250 μm. By having the thickness described above, the substrate layer may satisfy mechanical physical properties, and also significantly reduce a distortion phenomenon of light, when laminating the polyimide-based film.

In an exemplary embodiment of the present invention, specifically, for example, the optical adhesive layer may include any one or more selected from an optical clear adhesive (OCA), an optical clear resin (OCR), a pressure sensitive adhesive (PSA), and the like, but is not limited thereto.

In an exemplary embodiment of the present invention, the window cover film may further include a second optical adhesive layer on an interface between the substrate layer and the polyimide-based film.

Specifically, the second optical adhesive layer formed on the interface between the substrate layer and the polyimide-based film may be the same or different material as/from the optical adhesive layer in the substrate layer described above, and for example, may be formed to a thickness of 20 to 120 μm. Preferably, the thickness may be 20 to 80 μm. When the thickness is formed within the above range, the window cover film may implement overall excellent optical properties and a light distortion improvement effect.

In an exemplary embodiment of the present invention, the window cover film may have a high surface hardness, have excellent flexibility, be lighter than tempered glass, and have excellent durability against deformation, and thus, is excellent as a window substrate on the outermost surface of a flexible display panel.

Another exemplary embodiment of the present invention provides a display device including: a display panel and the window cover film described above formed on the display panel.

In an exemplary embodiment of the present invention, the display device is not particularly limited as long as it belongs to a field requiring excellent optical properties, and may be provided by selecting a display panel appropriate therefor. Preferably, the window cover film may be applied to a flexible display device, and specifically, for example, may be included and applied to any one or more image displays selected from various image displays such as a liquid crystal display, an electroluminescence display, a plasma display, and a field emission display device, but is not limited thereto.

The display device including the window cover film of the present invention described above has excellent display quality to be displayed and significantly decreased distortion caused by light, and thus, may have significantly improved rainbow in which iridescent stain occurs and minimize user's eye strain with excellent visibility.

Hereinafter, the present invention will be described in more detail with reference to the Examples and Comparative Examples. However, the following Examples and Comparative Examples are only an example for describing the present invention in detail, and do not limit the present invention in any way.

Hereinafter, the physical properties were measured as follows:

1) Pencil Hardness

According to JIS K 5400, a line of 20 mm was drawn at a rate of 50 mm/sec on a film using a load of 750 g, this operation was repeated 5 times or more, and the pencil hardness was measured based on the case in which one or more scratches occurred.

2) Elongation at Break

According to ASTM D882, the elongation at break was measured using UTM 3365 available from Instron, with the condition of pulling a polyamideimide film having a length of 50 mm and a width of 10 mm at 50 mm/min at 25° C.

The thickness of the film was measured and the value was input to the instrument. The unit of the modulus is GPa and the unit of the elongation at break is %.

3) Light Transmittance

In accordance with the standard of ASTM D1746, a total light transmittance was measured at the entire wavelength area of 400 to 700 nm using a spectrophotometer (from Nippon Denshoku, COH-400) and a single wavelength light transmittance was measured at 388 nm using UV/Vis (Shimadzu, UV3600), on a film having a thickness of 50 pm. The unit was %.

4) Haze

In accordance with the standard of ASTM D1003, the haze was measured based on a film having a thickness of 50 μm, using a spectrophotometer (from Nippon Denshoku, COH-400). The unit was %.

5) Yellowness (YI) and b* Value

In accordance with the standard of ASTM E313, the yellowness and the b* value were measured based on a film having a thickness of 50 μm, using a colorimeter (from HunterLab, ColorQuest XE).

6) Weight average molecular weight (Mw) and polydispersity index (PDI)

The weight average molecular weight and the polydispersity index of the prepared film were measured by dissolving a film sample in a DMAc eluent containing 0.05 M LiBr and using GPC (Waters GPC system, Waters 1515 isocratic HPLC Pump, Waters 2414 Refractive Index detector). During measurement, as a GPC column, Olexis, Polypore, and mixed D columns were connected, as a solvent, a DMAc solution was used, as a standard, polymethylmethacrylate (PMMA STD) was used, and the analysis was performed at 35° C. at a flow rate of 1 mL/min.

7) Dynamic Bending Properties

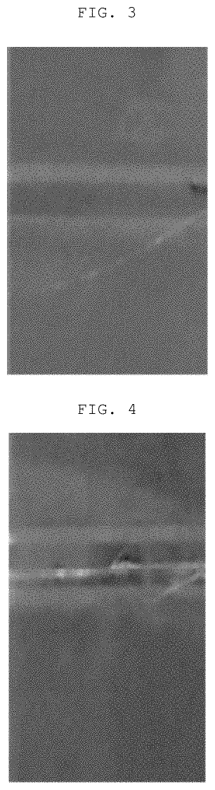

A film was cut into a size of a width of 100 mm and a length of 200 mm by laser and fixed to a folding tester (from YUASA) using an adhesive agent, a folding radius (R₁ of FIG. 1) was set at 5 mm, an infolding test (an inside of a coating surface, see FIG. 1) was performed 10,000 times, 30,000 times, 50,000 times, 80,000 times, and 100,000 times repeatedly at a rate of 60 cycles/min, an outfolding test (the opposite side, see FIG. 2) was performed on the same sample at the same number of times at the same rate so that the sample is folded at the same position (P), and the cracks in the folded part were visually confirmed. Fine cracks were observed by a microscope. FIG. 3 is a photograph illustrating that cracks did not occur, and FIG. 4 is a photograph illustrating that cracks occurred.

8) Micro flexural modulus and micro flexural strength

A micro 3-point bend fixture (Instron, CAT. #2810-411) was used for measuring the flexural strength due to fine deformation of a thin film. A sample was placed on two lower anvils and then a load was applied to one upper anvil. Here, the used anvil had radius of 0.25 mm. The loading was applied precisely to a span center between the two lower anvils. In the experiment, a supported span of the lower anvil was 4 mm.

Here, the size of the sample is prepared to have a width of 10 mm and a length of 20 mm. A test was performed by mounting a static load cell (CAT# 2530-50N) of 50 N on a single column tabletop testing system (CAT# 5942) from Instron, applying a preload of 0.2 N at a rate of 1 mm/min, and then pressing at a rate of 1 mm/min until a flexural strain of 2% is achieved. A pressed circular cross section had a diameter of 3 mm. An exact flexural displacement was precisely measured using Advanced Video Extensometer 2 (AVE 2, CAT# 2663-901) from Instron. AVE 2 tracked deformation of the part indicated in the sample using a built-in camera in a non-contacting optical extensometer.

Finally, a stress applied until a flexural strain of 2% was achieved was measured in 100 ms increments to determine the micro flexural strength and the micro flexural modulus (@ 2% strain). The micro flexural modulus, strength, and strain are values calculated based on an input program in Testing System from Instron.

### EXAMPLE 1

Terephthaloyl dichloride (TPC) and 2,2′-bis(trifluoromethyl)-benzidine (TFMB) were added to a mixed solution of dichloromethane and pyridine in a reactor, and stirring was performed at 25° C. for 2 hours under a nitrogen atmosphere. Here, a mole ratio of TPC:TFMB was 300:400, and adjustment was performed so that a solid content was 10 wt %. Thereafter, the reactant was precipitated in an excessive amount of methanol and filtered to obtain a solid content, which was dried under vacuum at 50° C. for 6 hours or more to obtain an oligomer, and the prepared oligomer had a formula weight (FW) of 1670 g/mol.

N,N-dimethylacetamide (DMAc), 100 mol of the oligomer, and 28.6 mol of 2,2′-bis(trifluoromethyl)-benzidine (TFMB) were added to the reactor and sufficient stirring was performed. After confirming that the solid raw material was completely dissolved, fumed silica (surface area of 95 m²/g, <1 μm) was added to DMAc at a content of 1000 ppm relative to the solid content, and added to the reactor after being dispersed using ultrasonic waves. 64.1 mol of cyclobutanetetracarboxylic dianhydride (CBDA) and 64.1 mol of 4,4′-hexafluoroisopropylidene diphthalic anhydride (6FDA) were subsequently added, sufficient stirring was performed, and the mixture was polymerized at 40° C. for 10 hours. Here, the solid content was 20%. Subsequently, each of pyridine and acetic anhydride was added at 2.5-fold relative to the total content of dianhydride, and stirring was performed at 60° C. for 12 hours.

After the polymerization was finished, the polymerization solution was precipitated in an excessive amount of methanol and filtered to obtain a solid content, which was dried under vacuum at 50° C. for 6 hours to obtain polyamideimide powder. The powder was diluted and dissolved at 20% in DMAc to prepare a polyimide-based resin solution.

The polyimide-based resin solution was applied on a glass substrate using an applicator, dried at 80° C. for 30 minutes and 100° C. for 1 hour, and cooled to room temperature to prepare a film. Thereafter, stepwise heat treatment was performed at a heating rate of 20° C./min at 100 to 200° C. and 250 to 300° C. for 2 hours.

As a result of measuring the physical properties of the thus-prepared polyamideimide film, the thickness was 50 μm, the total light transmittance was 89.73%, the haze was 0.4%, a yellowness (YI) was 1.9, the b* value was 1.0, the elongation at break was 21.2%, the weight average molecular weight was 310,000 g/mol, the polydispersity index (PDI) was 2.11, and the pencil hardness was HB/750 g.

In addition, it was confirmed that the micro flexural modulus was 16 GPa and the micro flexural strength was 220 MPa, and the results of measuring the dynamic bending properties are shown in Table 1.

### EXAMPLE 2

The same polyimide-based resin solution as that of Example 1 was used to apply the solution on a stainless belt by a slot-die. Here, the temperature of the stainless belt was 120° C., and the solution was dried for 20 minutes using drying wind at a speed of 3 m/s in a state that a temperature of the outside air is room temperature. Thereafter, a bench stretcher was used to stretch the film by 20% at a temperature of 230° C. at a rate of 10 mm/sec and the film was dried. Here, it was confirmed that the film had a content of a residual solvent therein of 2.5%, the micro flexural modulus of 14.7 GPa, and the micro flexural strength of 189 MPa, and the results of measuring the dynamic bending properties are shown in Table 1.

### EXAMPLE 3

Terephthaloyl dichloride (TPC) and 2,2′-bis(trifluoromethyl)-benzidine (TFMB) were added to a mixed solution of dichloromethane and pyridine in a reactor, and stirring was performed at 25° C. for 2 hours under a nitrogen atmosphere. Here, a mole ratio of TPC:TFMB was 300:400, and adjustment was performed so that a solid content was 10 wt %. Thereafter, the reactant was precipitated in an excessive amount of methanol and filtered to obtain a solid content, which was dried under vacuum at 50° C. for 6 hours or more to obtain an oligomer, and the prepared oligomer had a formula weight (FW) of 1670 g/mol.

N,N-dimethylacetamide (DMAc), 100 mol of the oligomer, and 50 mol of 2,2′-bis(trifluoromethyl)-benzidine (TFMB) were added to the reactor and sufficient stirring was performed. After confirming that the solid raw material was completely dissolved, fumed silica (surface area of 95 m²/g, <1 μm) was added to DMAc at a content of 1000 ppm relative to the solid content, and added to the reactor after being dispersed using ultrasonic waves.

50 mol of 4,4′-hexafluoroisopropylidene diphthalic anhydride (6FDA) and 50 mol of biphenyltetracarboxylic dianhydride (BPDA) were added and stirring was performed until the materials were dissolved, and then 50 mol of cyclobutanetetracarboxylic dianhydride (CBDA) was added and stirring was performed until the material was dissolved.

Subsequently, each of pyridine and acetic anhydride was added at 2.5-fold relative to the total added amount of dianhydride, and stirring was performed at 60° C. for 12 hours.

After the polymerization was finished, the polymerization solution was precipitated in an excessive amount of methanol and filtered to obtain a solid content, which was dried under vacuum at 50° C. for 6 hours to obtain polyamideimide powder. The powder was diluted and dissolved at 20% in DMAc to prepare a polyimide-based resin solution.

The polyimide-based resin solution was applied on a glass substrate using an applicator, dried at 80° C. for 30 minutes and 100° C. for 1 hour, and cooled to room temperature to prepare a film. Thereafter, stepwise heat treatment was performed at a heating rate of 20° C/min at 100 to 200° C. and 250 to 300° C. for 2 hours.

As a result of measuring the physical properties of the thus-prepared polyamideimide film, the thickness was 50 μm, the total light transmittance was 89.2%, the haze was 0.5%, a yellowness (YI) was 2.6, the b* value was 1.5, the elongation at break was 19.2%, the weight average molecular weight was 205,000 g/mol, the polydispersity index (PDI) was 2.11, and the pencil hardness was HB/750 g. Here, it was confirmed that the film had the micro flexural modulus of 12.4 GPa and the micro flexural strength of 167 MPa.

### EXAMPLE 4

Terephthaloyl dichloride (TPC) and 2,2′-bis(trifluoromethyl)-benzidine (TFMB) were added to a mixed solution of dichloromethane and pyridine in a reactor, and stirring was performed at 25° C. for 2 hours under a nitrogen atmosphere. Here, a mole ratio of TPC:TFMB was 250:400, and adjustment was performed so that a solid content was 10 wt %. Thereafter, the reactant was precipitated in an excessive amount of methanol and filtered to obtain a solid content, which was dried under vacuum at 50° C. for 6 hours or more to obtain an oligomer, and the prepared oligomer had a formula weight (FW) of 1470 g/mol.

N,N-dimethylacetamide (DMAc), 100 mol of the oligomer, and 70 mol of 2,2′-bis(trifluoromethyl)-benzidine (TFMB) were added to the reactor and sufficient stirring was performed. After confirming that the solid raw material was completely dissolved, fumed silica (surface area of 95 m²/g, <1 μm) was added to DMAc at a content of 1000 ppm relative to the solid content, and added to the reactor after being dispersed using ultrasonic waves.

50 mol of 4,4′-hexafluoroisopropylidene diphthalic anhydride (6FDA) and 50 mol of biphenyltetracarboxylic dianhydride (BPDA) were added and stirring was performed until the materials were dissolved, and then 50 mol of cyclobutanetetracarboxylic dianhydride (CBDA) was added and stirring was performed until the material was dissolved.

Subsequently, each of pyridine and acetic anhydride was added at 2.5-fold relative to the total added amount of dianhydride, and stirring was performed at 60° C. for 12 hours.

After the polymerization was finished, the polymerization solution was precipitated in an excessive amount of methanol and filtered to obtain a solid content, which was dried under vacuum at 50° C. for 6 hours to obtain polyamideimide powder. The powder was diluted and dissolved at 20% in DMAc to prepare a polyimide-based resin solution.

The polyimide-based resin solution was applied on a glass substrate using an applicator, dried at 80° C. for 30 minutes and 100° C. for 1 hour, and cooled to room temperature to prepare a film. Thereafter, stepwise heat treatment was performed at a heating rate of 20° C./min at 100 to 200° C. and 250 to 300° C. for 2 hours.

As a result of measuring the physical properties of the thus-prepared polyamideimide film, the thickness was 50 μm, the total light transmittance was 89.7%, the haze was 0.4%, a yellowness (YI) was 2.7, the b* value was 1.6, the elongation at break was 16.8%, the weight average molecular weight was 125,000 g/mol, the polydispersity index (PDI) was 2.23, and the pencil hardness was B/750 g. Here, it was confirmed that the film had the micro flexural modulus of 10.3 GPa and the micro flexural strength of 153 MPa.

### COMPARATIVE EXAMPLE 1

100 mol of N,N-dimethylacetamide (DMAc) and 2,2′-bis(trifluoromethyl)-benzidine (TFMB) were added to a reactor under a nitrogen atmosphere and sufficient stirring was performed, 30 mol of 4,4′-hexafluoroisopropylidene diphthalic anhydride (6FDA) was added thereto, and sufficient stirring was performed until the material was dissolved. Thereafter, 30 mol of 3,3′,4,4′-biphenyltetracarboxyldianhydride (BPDA) was added and sufficient stirring was performed until the material was dissolved. Thereafter, 40 mol of terephthaloyl dichloride (TPC) was introduced and stirring was performed for 6 hours to carry out dissolution and reaction, thereby producing a polyamic acid resin composition. Each monomer was adjusted to have a solid content of 6.5 wt %. Each of Pyridine and acetic anhydride was subsequently added to the composition at 2.5-fold of the total moles of dianhydride, and stirring was performed at 60° C. for 1 hour. Thereafter, the solution was precipitated in an excessive amount of methanol and the precipitate was filtered to obtain a solid content, which was dried under vacuum at 50° C. for 6 hours to obtain polyamideimide powder. The powder was diluted and dissolved at 20 wt % in DMAc to prepare a composition for forming a substrate layer.

A film was prepared from the composition for forming a substrate layer under the same conditions as Example 1. The film had a thickness of 50 μm. As a result of measuring the physical properties of the prepared film, the total light transmittance was 87.02%, the haze was 0.67%, the yellowness (YI) was 2.6, and the b* value was 1.55.

In addition, it was confirmed that the film had the micro flexural modulus of 9.5 GPa and the micro flexural strength of 148 MPa, and the results of measuring the dynamic bending properties are shown in Table 1.

TABLE 1

| | Micro | Micro | | | | | | |
|---|---|---|---|---|---|---|---|---|
| | flexural | flexural | | Cracks | | | | |
| | modulus | strength | | 10,000 | 30,000 | 50,000 | 80,000 | 100,000 |
| | (GPa) | (MPa) | A/B | times | times | times | times | times |
| Example 1 | 16 | 220 | 0.65 | X | X | X | X | X |
| Example 2 | 14.7 | 189 | 0.76 | X | X | X | X | ◯ |
| Example 3 | 12.4 | 167 | 0.87 | X | X | X | ◯ | ◯ |
| Example 4 | 10.3 | 153 | 0.8 | X | X | ◯ | ◯ | ◯ |
| Comparative | 9.5 | 148 | 0.48 | ◯ | ◯ | ◯ | ◯ | ◯ |
| Example 1 | | | | | | | | |

As seen from Table 1, it was found that the products prepared in the Examples were confirmed to have no fine cracks even after the dynamic bending evaluation of 30,000 times, and it was confirmed that by supplying the product having no cracks even in the evaluation of 30,000 times, a cover window having excellent bending property durability may be manufactured.

Since the polyimide-based film of the present invention has an excellent bending properties, it has no permanent deformation and/or damage even when predetermined deformation occurs repeatedly and may be restored to its original form.

Accordingly, the polyimide-based film may be applied to a window cover film which may be applied to a display having a curved shape, a foldable device, or the like.

In addition, the window cover film using the polyimide-based film of the present invention has no fine cracks even after repeated bending. Accordingly, durability and long-term life of the flexible display may be secured.

Hereinabove, although the present invention has been described by specific matters, limited exemplary embodiments, and drawings, they have been provided only for assisting the entire understanding of the present invention, and the present invention is not limited to the exemplary embodiments, and various modifications and changes may be made by those skilled in the art to which the present invention pertains from the description.

Therefore, the spirit of the present invention should not be limited to the above-described exemplary embodiments, and the following claims as well as all modified equally or equivalently to the claims are intended to fall within the scope and spirit of the invention.

What is claimed is:

1. A polyimide-based film having a micro flexural modulus of 10 to 20 GPa and a micro flexural modulus of 150 MPa or more,
wherein the micro flexural modulus and the micro flexural strength refer to a modulus of elasticity and a strength measured as follows: a film having a width of 10 mm and a length of 20 mm is placed between a lower anvil and an upper anvil of a micro 3-point bend fixture including two lower anvils each spaced at an interval of 4 mm and one upper anvil having a radius of 0.25 mm, a preload of 0.2 N is applied at a rate of 1 mm/min using a load cell of 50 N, and then the film is pressed at a rate of 1 mm/min until a flexural strain of 2% is achieved, the modulus of elasticity and the strength being measured from a flexural stress applied thereto.

2. The polyimide-based film of claim 1, wherein the micro flexural modulus is 15 GPa or more and the micro flexural strength is 200 MPa or more.

3. The polyimide-based film of claim 1, wherein a flexural displacement is 0.5 to 0.7 mm, the flexural displacement referring to a displacement measured when a flexural strain of 2% is achieved.

4. The polyimide-based film of claim 1, wherein the polyimide-based film satisfies the following relation:
0.5<A/B<1.0
wherein A is a flexural stress value (MPa) when a flexural strain is 1%, and B is a flexural stress value (MPa) when a flexural strain is 2%.

5. The polyimide-based film of claim 1, wherein an elongation at break according to ASTM D882 is 8% or more.

6. The polyimide-based film of claim 1, wherein the polyimide-based film has a light transmittance of 5% or more as measured at 388 nm according to ASTM D1746, a total light transmittance of 87% or more as measured at 400 to 700 nm, a haze of 2.0% or less, a yellowness of 5.0 or less, and a b* value of 2.0 or less.

7. The polyimide-based film of claim 1, wherein the polyimide-based film includes a polyamideimide structure.

8. The polyimide-based film of claim 7, wherein the polyimide-based film includes a unit derived from a fluorine-based aromatic diamine, a unit derived from an aromatic dianhydride and a unit derived from an aromatic diacid dichloride.

9. The polyimide-based film of claim 8, wherein the polyimide-based film further includes a unit derived from a cycloaliphatic dianhydride.

10. The polyimide-based film of claim 1, wherein the polyimide-based film has a thickness of 10 to 500 μm.

11. A window cover film comprising:
the polyimide-based film of claim 1; and
a coating layer formed on one surface of the polyimide-based film.

12. The window cover film of claim 11, wherein the coating layer is any one or more selected from an antistatic layer, an anti-fingerprint layer, an antifouling layer, an anti-scratch layer, a low-refractive layer, an antireflective layer, and shock absorption layer.

13. A flexible display panel comprising the polyimide-based film of claim 1.
